(19) United States
(12) Patent Application Publication
(10) Pub. No.: US 2012/0192689 A1
(43) Pub. Date: Aug. 2, 2012

(54) GUIDE ASSEMBLY AND SHEET MATERIAL SLITTER INCORPORATING THE SAME

(75) Inventors: Adam J. Binderup, Westminster, CO (US); Ronald W. Schell, Firestone, CO (US)

(73) Assignee: NEW TECH MACHINERY, Denver, CO (US)

(21) Appl. No.: 13/019,513

(22) Filed: Feb. 2, 2011

(51) Int. Cl. B26D 3/12; B26D 7/01; B26D 1/143

(52) U.S. Cl. 83/13; 83/418; 83/825

(57) ABSTRACT

A sheet material slitter with a guide assembly for receiving the edges of material along a slit formed in the sheet material. The slitter includes a cutting assembly in the form of a pair of cooperative slitting knives rotatably mounted in axially offset relation. A drive motor is coupled to the slitting knives and operative to counter-rotate the knives such that sheet material fed into the slitter is drawn through the slitter as the material is cut to form a slit. The guide assembly is mounted adjacent the slitting knives and comprises a pair of guide rollers rotatably supported in axially spaced relation. Each guide roller is capable of receiving a respective edge of material along the slit formed in the sheet material. The guide rollers are supported in substantially parallel relation to one another and may be supported at an angle with respect to the slitting knives.

### BACKGROUND

In a sheet metal slitter, material is cut as it passes through a cutter often comprising a stationary pair of opposed circular knives. The knives are driven in opposite directions to each other to pull the material through the machine.

A traditional sheet metal slitter employs a guide to engage the edge of the material in order to cut a panel on a straight path. Where it is desired to cut a panel having an angled or tapered edge a traditional slitter machine cannot be used because the panel must be fed at an angle to the cutter, which causes the panel to interfere with the guide.

In order to produce a tapered panel, such as those used in metal roofing, the panel must be cut by hand or cut in a programmable taper slitter machine. Cutting the panel by hand is time consuming, particularly when installing a metal roof with multiple panels. Programmable taper slitter machines are expensive and more appropriate for high volume production rather than on-site panel slitting and forming processes. Furthermore, traditional slitting machines are not able to accept panels that have a previously formed leg, as the leg interferes with the guide, rollers, drive shafts, and framework of traditional machines.

Accordingly, there is a need for a cost effective and versatile slitter machine that is capable of cutting tapered panels along a straight path. Moreover there is a need for a slitter machine that can accept panels having previously formed leg portions.

### SUMMARY

Described herein is a sheet material slitter apparatus that has a guide assembly capable of receiving the edges of material along a slit formed in the sheet material. The slitter includes a cutting assembly. In an embodiment, the cutting assembly is a pair of cooperative slitting knives rotatably mounted in axially offset relation relative to each other. A drive motor is coupled to the pair of slitting knives and operative to counter-rotate the slitting knives such that sheet material fed into the slitter is drawn through the slitter as the material is cut to form a slit. In other words, the cutting assembly progressively cuts the sheet material into first and second segments having first and second edge margins respectively.

A guide assembly is mounted adjacent the slitting knives. The guide assembly comprises a pair of guide rollers rotatably supported in axially spaced relation relative to each other. Each guide roller is capable of receiving a respective edge of material along the slit formed in the sheet material exiting the slitting knives. Each guide roller includes a respective groove and the guide rollers are supported such that each respective groove is capable of receiving a respective edge of the slit. The guide rollers may be in the form of sheaves. The guide rollers are supported in substantially parallel relation to one another and may be supported at an angle with respect to the slitting knives. For example, the pair of grooved guide rollers may be oriented at an angle of at least 45 degrees from the pair of slitter knives. The guide rollers may be supported such that they are oriented at an angle relative to each other.

In an exemplary embodiment, the pair of slitting knives includes an upper knife and a lower knife. The pair of guide rollers includes an upper guide roller and a lower guide roller each oriented orthogonally to the slitter knives. The upper guide roller is positioned to receive an edge of the slit on the same side of the slit as the lower knife and the lower guide roller is positioned to receive an edge of the slit on the same side of the slit as the upper knife. The slitter may also include an alignment indicator, such as a laser, located adjacent the slitting knives and opposite the guide assembly.

The slitter may include a frame that has an entryway with a width and a height. The frame is configured to support the slitting knives and the guide assembly at a location along the width. In an embodiment, the slitting knives and the guide assembly are located approximately in the middle of the width or approximately midway between lateral side ends of the entryway. The motor is attached to an end of the frame, and a pair of drive shafts extend only partially across the width of the frame from the motor to the slitter knives. Accordingly, at least a portion of the entryway is unobstructed along the frame's width. The sheet material slitter apparatus may include at least one accessory attachment. For example, the frame may be supported by a support stand. The apparatus may also include an upstream support table and a downstream support table to aid in feeding sheet material such as sheet metal through the slitter.

Also contemplated is a guide assembly for use on a sheet material slitter that includes a pair of slitting knives. The guide assembly includes a pair of grooved guide rollers each rotatably mounted on a roller mount. Each roller mount is adapted for attachment to the slitter adjacent the slitting knives. The grooved guide rollers are supported in axially spaced relation to each other and supported such that the groove on each guide roller is capable of receiving a respective edge of material along the slit formed in the sheet material as it exits the slitting knives.

Also contemplated herein are methods of slitting sheet material. In an embodiment, the method may include providing a cutting assembly and feeding the sheet material into said cutting assembly. The cutting assembly progressively cuts the sheet material into first and second segments having first and second edge margins respectively. The first and second edge margins are received and supported one above the other. In an embodiment the method may include providing a sheet material slitter having a cutting assembly. The method includes aligning the sheet material at a desired angle relative to the cutting assembly and inserting the material into the slitter entryway to engage the cutting assembly. The cutting assembly thereby progressively cuts the sheet material into first and second segments having first and second edge margins respectively. The edge margins are captured with first and second guide rollers respectively at a location downstream of the cutting assembly.

These and other aspects of the present apparatus and methods will be apparent after consideration of the Detailed Description and Figures herein. It is to be understood, however, that the scope of the invention shall be determined by the claims as issued.

### BRIEF DESCRIPTION OF THE DRAWINGS

Non-limiting and non-exhaustive embodiments of the present invention, including the preferred embodiment, are described with reference to the following figures, wherein like reference numerals refer to like parts throughout the various views unless otherwise specified.

FIG. 1 is a perspective view of a sheet material slitter apparatus according to an exemplary embodiment;

FIG. 2 is a right side view in elevation of the sheet material slitter apparatus shown in FIG. 1;

FIG. 3 is a top plan view of the sheet material slitter apparatus shown in FIGS. 1 and 2;

FIG. 4 illustrates a piece of sheet material before slitting;

FIG. 5 illustrate a piece of sheet material after slitting;

FIG. 6 is an enlarged perspective view of the sheet material slitter shown in FIGS. 1-3;

FIG. 7 is a front view of the slitter shown in FIG. 6 as viewed from the entryway of the slitter;

FIG. 8 is an enlarged partial right side view of the slitter shown in FIGS. 1-3;

FIG. 9 is a perspective view of the cutting assembly shown in FIGS. 6 and 7;

FIG. 10 is an enlarged partial perspective view of the slitter as viewed from the exit of the slitter;

FIG. 11 is a perspective view of the slitter's guide assembly;

FIG. 12 is a front view of the guide assembly shown in FIG. 11;

FIG. 13 is a right side view of the guide assembly shown in FIG. 11;

FIG. 14 is a top view of the guide assembly shown in FIG. 11;

FIG. 15 is a rear view of the guide assembly shown in FIG. 11;

FIG. 16 is an illustration of the guide rollers receiving respective edges of material along a slit formed in a piece of sheet material;

FIG. 17 is a perspective view of the sheet material slitter incorporating an optional laser alignment indicator;

FIG. 18 is a perspective view of a sheet material slitter apparatus according to an alternative exemplary embodiment including an entry guide assembly;

FIG. 19 is a front view in elevation of the entry guide assembly shown in FIG. 18;

FIG. 20 is a top plan view of the entry guide assembly shown in FIG. 19;

FIG. 21 is a right side view of the entry guide assembly shown in FIGS. 19 and 20;

FIG. 22A is a perspective view of the entry guide assembly shown in FIGS. 19-21 with the entry guide carriage in a first guide position;

FIG. 22B is a perspective view of the entry guide assembly shown in FIGS. 19-21 with the entry guide carriage in a second guide position;

FIG. 23A is a perspective view of the entry guide carriage shown in FIGS. 19-21 with the entry rollers in a first position; and

FIG. 23B is a perspective view of the entry guide carriage shown in FIGS. 19-21 with the entry rollers in a second position.

### DETAILED DESCRIPTION

Embodiments are described below with reference to the accompanying figures, which form a part hereof and show, by way of illustration, specific exemplary embodiments. These embodiments are disclosed in sufficient detail to enable those skilled in the art to practice the invention. However, embodiments may be implemented in many different forms and the invention should not be construed as being limited to the embodiments set forth herein. The following detailed description is, therefore, not to be taken in a limiting sense.

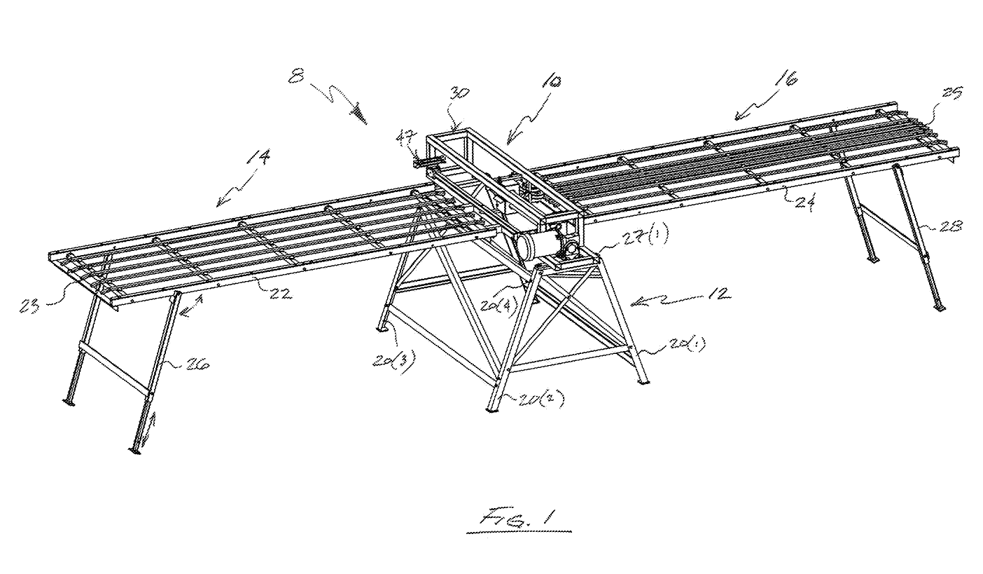

FIGS. 1-3 illustrate a sheet material slitter apparatus 8 including a sheet material slitter 10 and accessory attachments in the form of a support stand 12, an upstream support table 14, and a downstream support table 16. Support stand 12 includes a plurality of legs 20(1)-20(4) which extend upwardly from a support surface to mounting pads 27(1)-27(4). Mounting pads 27 are used to attach frame 30 of slitter 10 to the support stand.

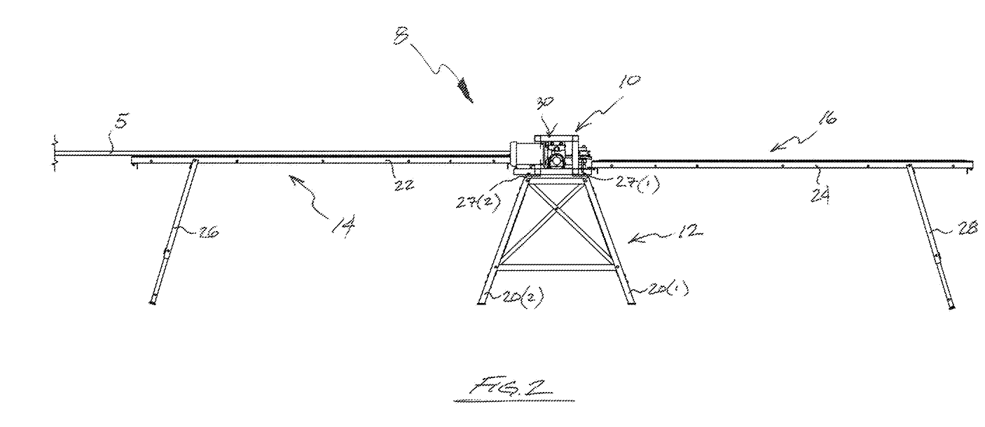

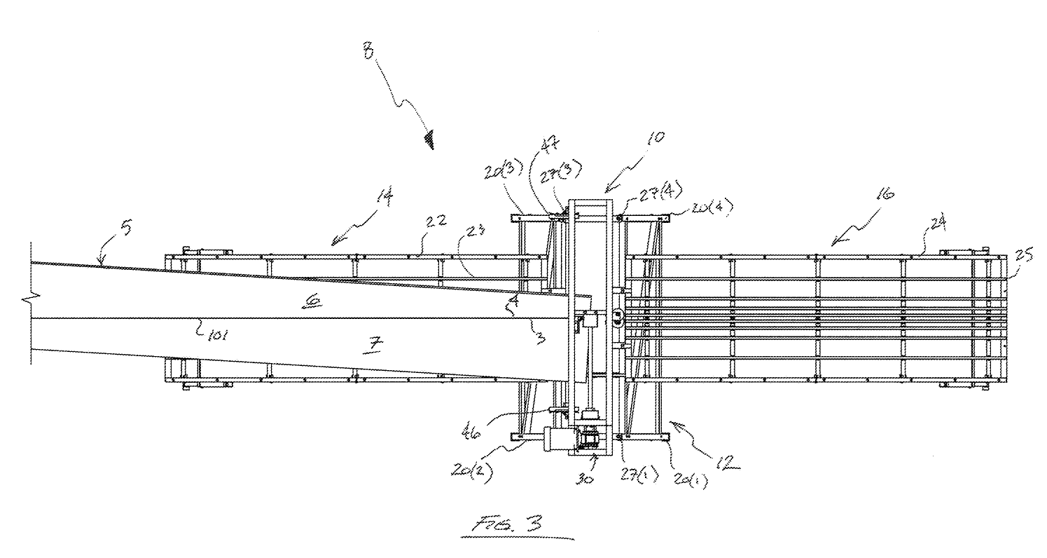

The panel support tables (upstream support table 14 and downstream support table 16) are positioned proximate the upstream and downstream openings of frame 30. Frame 22 of upstream support table 14 is attached to frame 30 at one end and supported at the other end by leg assembly 26. Frame 24 of downstream table 16 is similarly attached to frame 30 at one end and supported at the other end by leg assembly 28. Leg assemblies 26 and 28 are foldable with respect to their corresponding frames and may include extendable legs. Panel support tables 14 and 16 also include a plurality of transversely spaced apart slide rails 23 and 25 respectively. As shown in FIGS. 2 and 3, upstream table 14 supports a sheet material panel 5 as it is fed into slitter 10. Downstream table 16 receives panel segments 6 and 7 as they exit the slitter 10. Slide rails 23 and 25 are rib like structures extending along the length of their respective tables. Slide rails 23 and 25 may be comprised of aluminum extrusion that holds plastic material, such as high-density polyethylene (HDPE) strips.

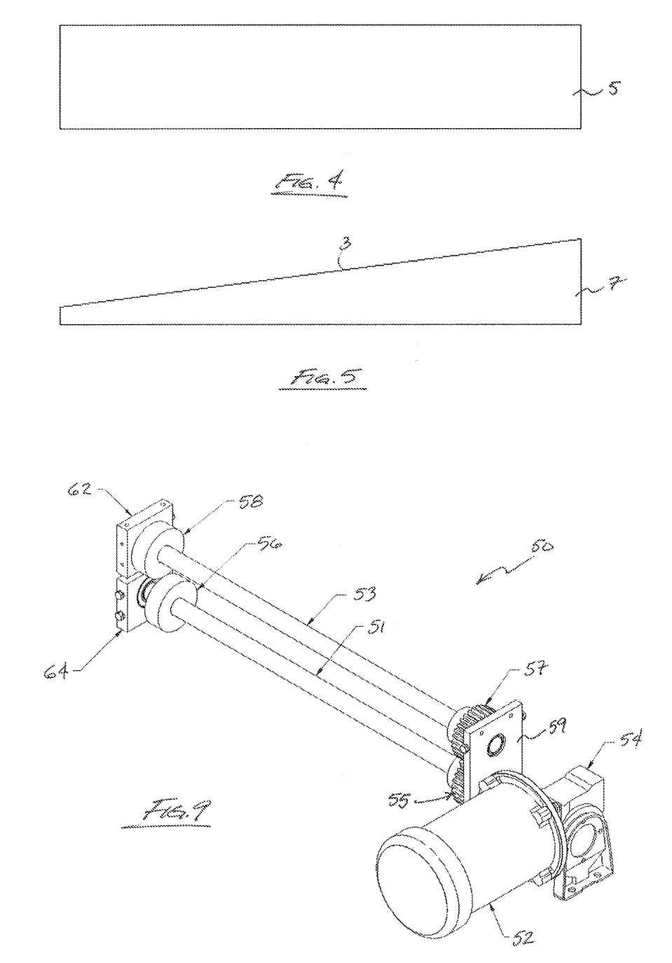

With reference to FIGS. 1 and 3, optional side guides 46 and 47 may be included on frame 30. Side guides 46 and 47 may be used for slitting a panel in a straight line as shown in FIG. 5. However, as shown in FIG. 3, a panel may also be cut at an angle to form a tapered panel. Sheet material 5 is fed into slitter 10 along marking 101, resulting in panel segments 6 and 7. For example, as shown in FIG. 5, panel 7 has a tapered edge 3.

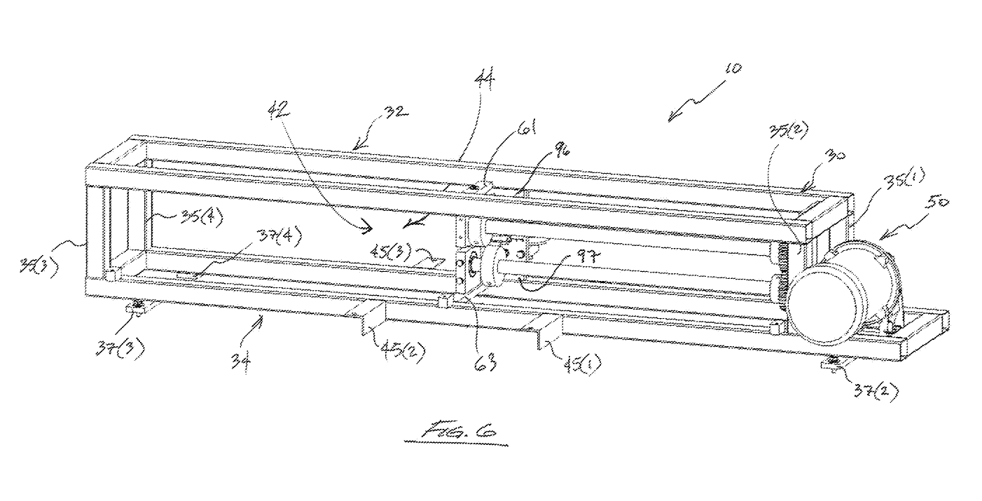

As shown in FIG. 6, frame 30 includes upper frame assembly 32 and lower frame assembly 34, which are spaced apart and connected by laterally spaced vertical frame members 35(1)-35(4). Thus, with further reference to FIG. 7, frame 30 defines an opening having a width W and a height H. Returning to FIG. 6, it can be appreciated that frame 30 supports a cutting assembly shown here in the form of a slitter knife assembly 50. Entryway 42 is the upstream or feed side of frame 30 which is adjacent the slitter knife assembly 50. Accordingly, exit opening 44 is the downstream or exit side of frame 30.

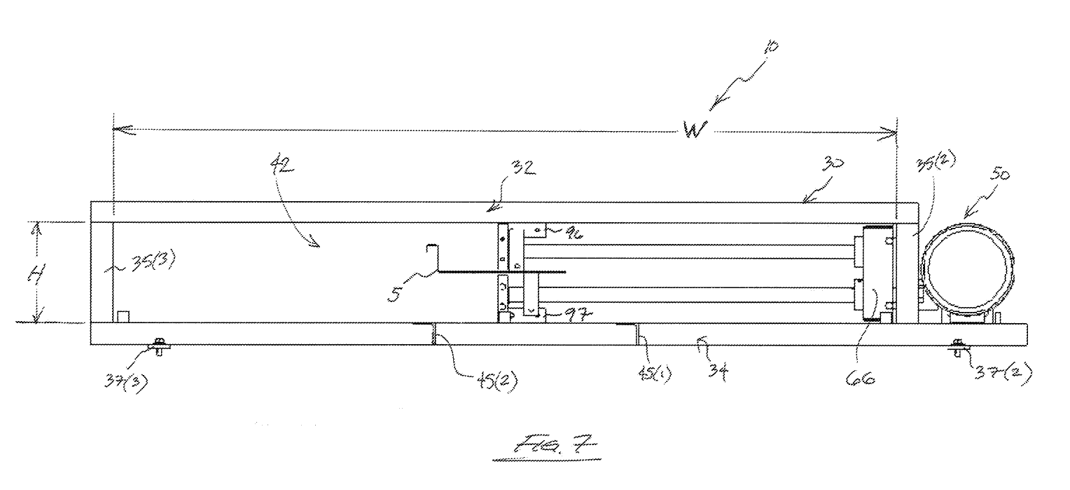

With reference to FIGS. 6-8, frame 30 includes a plurality of tabs and mounts for attaching various components of the slitter and ancillary components, such as the panel support tables 14, 16, and stand 12. For instance, lower frame assembly 34 includes mounting tabs 37(1)-37(4) that mate with mounting pads 27(1)-27(4) of stand 12, whereby the slitter 10 may be attached to support stand 12. Frame 30 also includes a plurality of table mounts 45(1)-45(4) for attachment to a respective upstream or downstream table 14 or 16. Knife assembly 50 is attached to frame 30 with mounts 61, 63, 65, and 67. Generally, these tabs and mounts may be welded to the frame. The components or assemblies that mate to each of these tabs and mounts are generally fastened thereto with appropriate hardware such as screws, bolts, nuts, and washers.

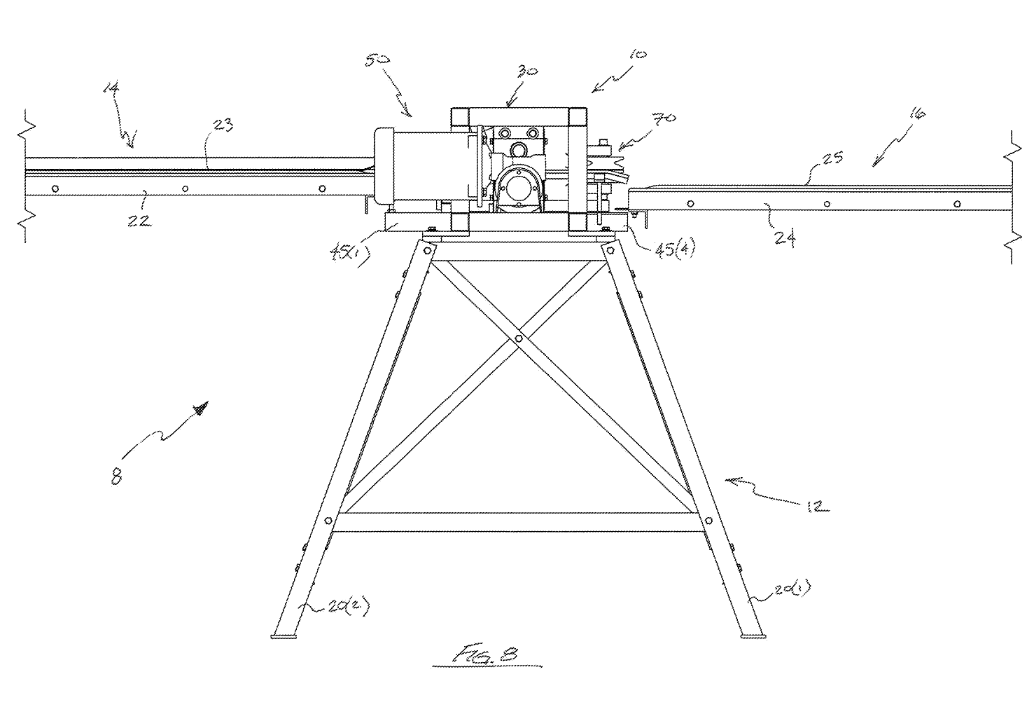

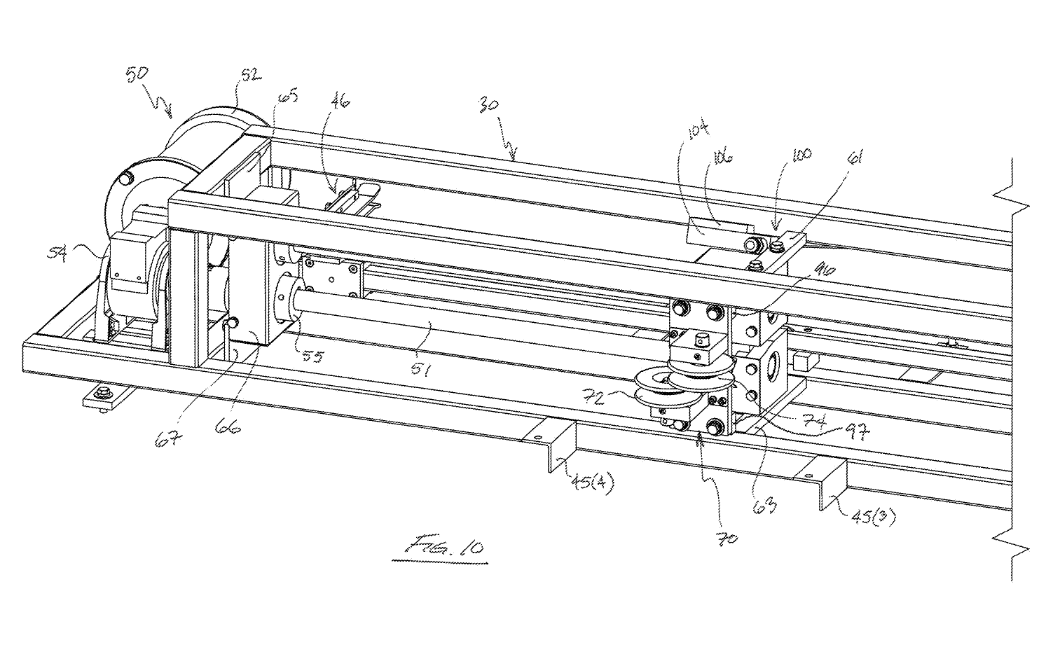

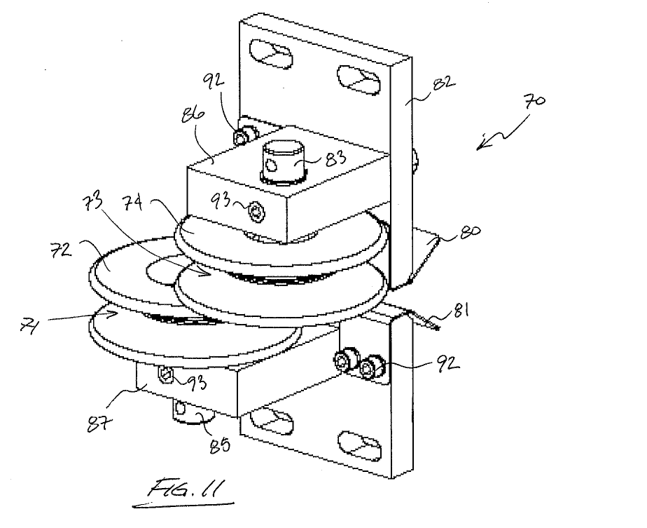

As shown in FIG. 9, slitter knife assembly 50 includes a drive motor 52 coupled to a right angle gear reducer 54 that, as is known in the art, provides a downstream speed less than that provided by motor 52. The speed is reduced such that the cutting speed of the knife assembly 50 is suited for manual feed. Also as known in the art, gear reducer 54 increases the torque provided to the cutter knives via drive shafts 51 and 53. Drive motor 52 may be powered and controlled with suitable wiring, switches, and control technology as known in the art. The reducer 54 is coupled to lower drive shaft 51 which in turn is geared to upper drive shaft 53 whereby drive shaft 51 and 53 counter-rotate. Gear 55 is disposed on driveshaft 51 and engages gear 57 that is disposed on driveshaft 53. Drive shafts 51 and 53 are supported at one end by bearing plate 59 and supported at the opposite end by bearing blocks 64 and 62 respectively. Knife assembly 50 also includes a cover 66 for covering gears 55 and 57 (see FIGS. 7 and 10, for example). Lower slitting knife 56 and upper slitting knife 58 are mounted to drive shafts 51 and 53 respectively and are axially offset relative to each other. Slitting knives 56 and 58 are cylindrical in configuration and work in cooperation to cut sheet metal as it is fed into the slitter 10 by shearing the material between the edges of the knives. Knives 56 and 58 may be formed of any suitable material such as hardened steel, for example.

Returning briefly to FIGS. 6 and 7, it may be appreciated that knife assembly 50 is supported in frame 30 such that slitting knives 56 and 58 are supported along the width W of entryway 42. In this case, for example, slitter knives 56 and 58 are located approximately in the middle of width W, or in other words, located approximately midway between lateral side ends of the entryway that extends between vertical uprights 35(1)-35(4). With reference to FIG. 7, it should be appreciated that the entryway opening 42 and exit opening 44 are sized in height H such that a formed panel 5 may be fed into slitter 10 for slitting even after the panel has been formed.

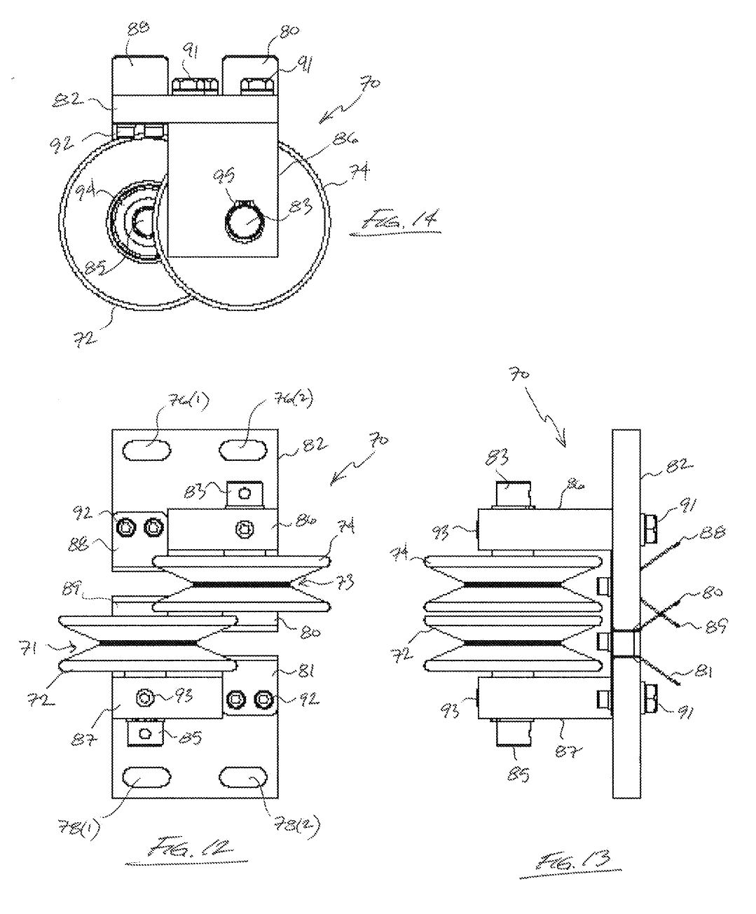

As shown in FIG. 10, frame 30 also supports guide assembly 70 which is mounted adjacent the slitting knives 56 and 58 in exit opening 44. Guide assembly 70 includes mounting plate 82 that attaches to mounts 96 and 97 on frame 30. Attached to mounting plate 82 are bearing blocks 86 and 87 that support axles 83 and 85 respectively. Axles 83 and 85 are secured against rotation in their respective bearing blocks with set screws 93. Axles 83 and 85 are retained in their respective bearing blocks with a retaining ring 95 (see FIG. 14). Guide roller 74 is rotatably supported on axle 83 and may include a bearing 94 to facilitate rotation of roller 74. Similarly, guide roller 72 is supported on axle 85 and may include a bearing 94. Rollers 72 and 74 include respective grooves 71 and 73 that are capable of receiving a respective edge of material along a slit formed in sheet material exiting slitter 10. Bearing blocks 86 and 87 are, in this case, attached to mounting plate 82 with fasteners 91. Guide assembly 70 includes panel deflectors 80, 81, 88, and 89 which help to initially direct the material toward grooves 71 and 73 of the guide rollers. The panel deflectors are attached to mounting plate 82 adjacent corresponding slots 75 and 77, which are shown in FIG. 15 (deflectors 80, 81, 88, and 89 are removed for clarity). Slots 75 and 77 provide clearance for the panel segments as they travel through slitter 10. It should be appreciated that slots 75 and 77 provide clearance for the panel segments while allowing mounting plate 82 to be a single unitary piece extending between the upper and lower frame assemblies (32, 34). Thus, mounting plate 82 helps reduce deflection of the frame by connecting the upper and lower frame assemblies. Each panel deflector is attached to mounting plate 82 with fasteners 92. The fasteners may be threaded fasteners, such as socket head cap screws or cap screws, for example.

In this case, guide rollers 72 and 74 are sheaves and are supported in substantially parallel relation to one another. Furthermore, guide rollers 72 and 74 are supported at an angle with respect to slitting knives 58 and 56. Specifically, as shown in, for example FIG. 6, guide rollers 72 and 74 are oriented at a 90 degree angle with respect to knives 58 and 56. It should be appreciated, however, that guide rollers 72 and 74 may be oriented at different angles, whereby their respective grooves 71, 73 are capable of receiving a respective edge of material along a slit formed in sheet material exiting slitter 10. For example, the pair of grooved guide rollers may be oriented at an angle of at least 45 degrees from the pair of slitter knives. Moreover, while guide rollers 72 and 74 are shown parallel to each other, guide roller 72 and 74 may be angled with respect to each other at any suitable angle such that their respective grooves 71, 73 are capable of receiving a respective edge of material along a slit formed in sheet material exiting slitter 10.

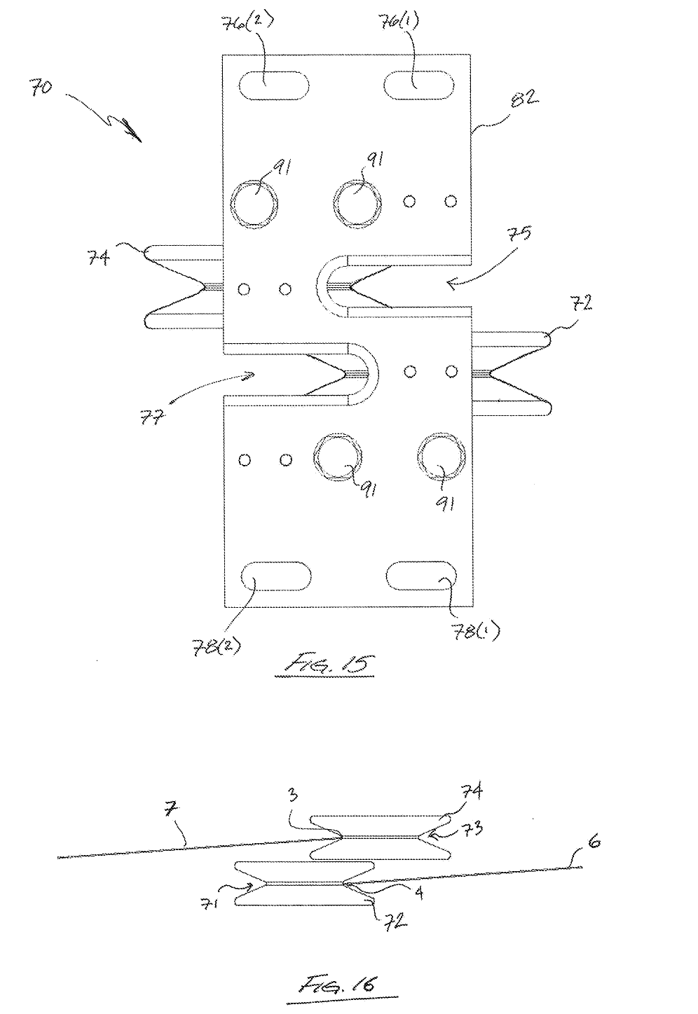

Referring to FIG. 16, it can be appreciated that upper guide roller 74 is positioned to receive an edge margin 3 of panel segment 7 on the same side of the slit as the lower knife 56 and the lower guide roller 72 is positioned to receive an edge margin 4 of panel segment 6 on the same side of the slit as the upper knife 58. In operation, a piece of sheet material 5 is fed through slitter knives 56 and 58 thereby cutting a slit to form panel segments 6 and 7 each of which have a respective edge margin 4 and 3. The edges along either side of the resulting slit engage grooves 71 and 73 of guide rollers 72 and 74, respectively. The sheet material tends to continue through the slitter along a straight line defined by a point where the knives engage the material and a point where the guide rollers capture the material.

FIG. 17 illustrates a partial cutaway of frame 32 so that alignment indicator 100 may be more easily viewed. Alignment indicator 100 is located adjacent the slitting knives and opposite the guide assembly 70. Alignment indicator 100 includes bracket 104 which is bolted to mount 106. Mount 106 is welded to frame 30. Bracket 104 supports a laser 102 which projects a beam 107 onto material 5. As shown in the figure, laser 102 is angled so that beam 107 projects onto the sheet material a distance from the entryway 42 and slitting knives 56 and 58. Thus, sheet material 5 may be fed into knives 56 and 58 along a marking 101. Accordingly, the alignment indicator aides a user in feeding a piece of sheet material into the slitter along a desired path. Once the material is fed into the slitter the guide assembly 70 aides in slitting the material along a straight line. The laser may be battery powered or powered by an external source as known in the art.

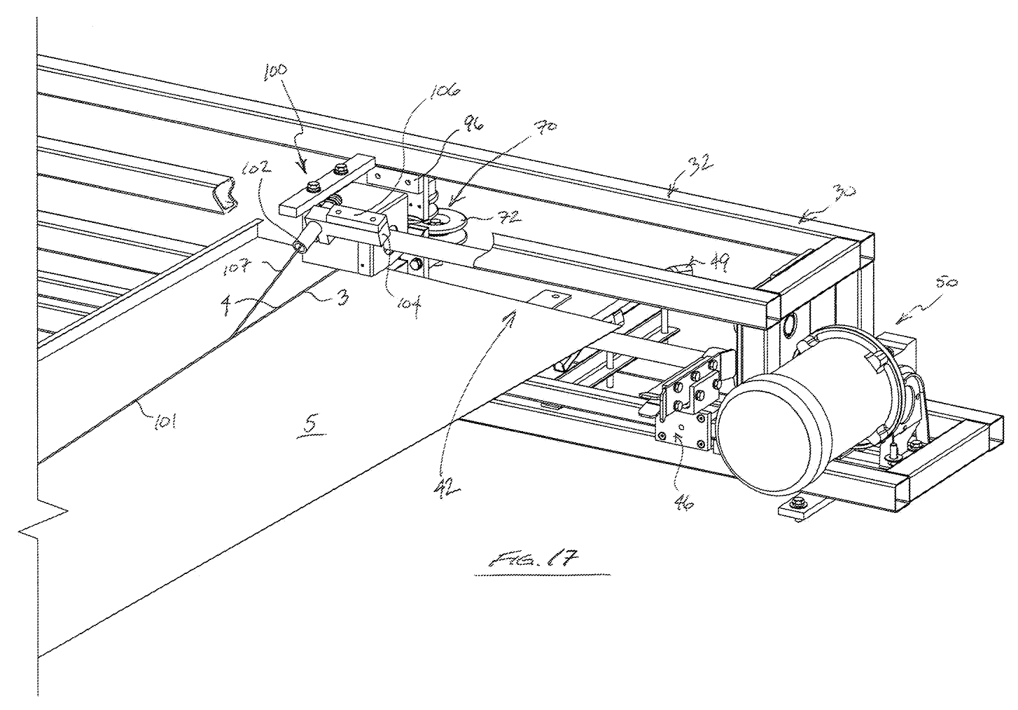

FIG. 18 illustrates a sheet material slitter apparatus 108 according to an alternative exemplary embodiment. Sheet material slitter apparatus 108 includes a slitter 110, an upstream support table 114, and entry guide assembly 200. Slitter 110 is similar to slitter 10 as described above. However, in this embodiment, slitter frame 130 includes entry guide assembly mounts 145(1) and 145(2). These mounts may be welded or fastened to frame 130. Entry guide assembly 200 mounts to guide assembly mounts 145(1) and 145(2), as shown in FIG. 18.

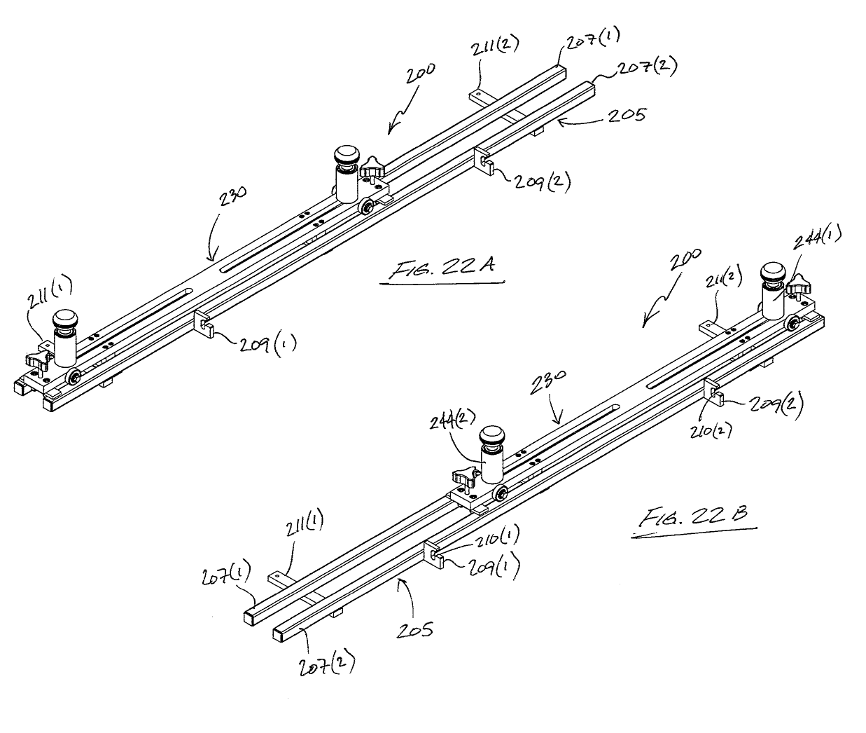

In this embodiment, upstream support table 114 includes a support surface 123 that is supported by leg assembly 126 at one end and attached to the entry guide assembly 200 at the other. In this case, support surface 123 is in the form of a flat table top that may be comprised of sheet metal or a sheet of plastic, for example. As can be seen in the figure, support table 114 includes a pair of pins 132(1) and 132(2) that engage table brackets 209(1) and 209(2), respectively that are disposed on entry guide assembly 200 (FIGS. 22A and 22B). Support table 114 also includes brackets 134(1) and 134(2), which are similar to table brackets 209(1) and 209(2). Thus, multiple support tables 114 may be linked together to create an upstream support surface as desired.

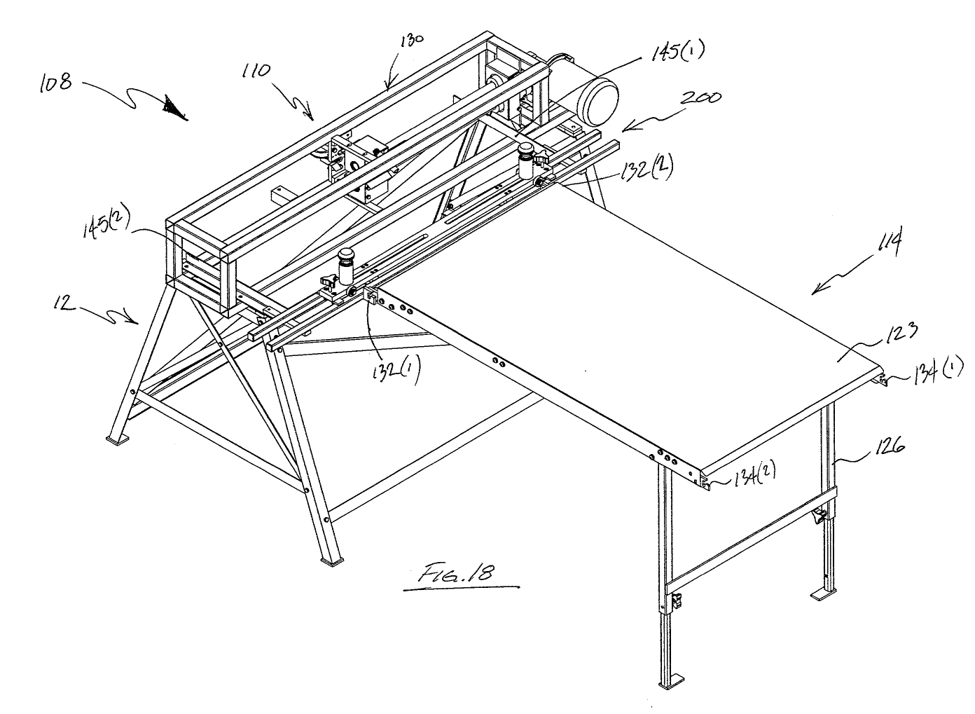

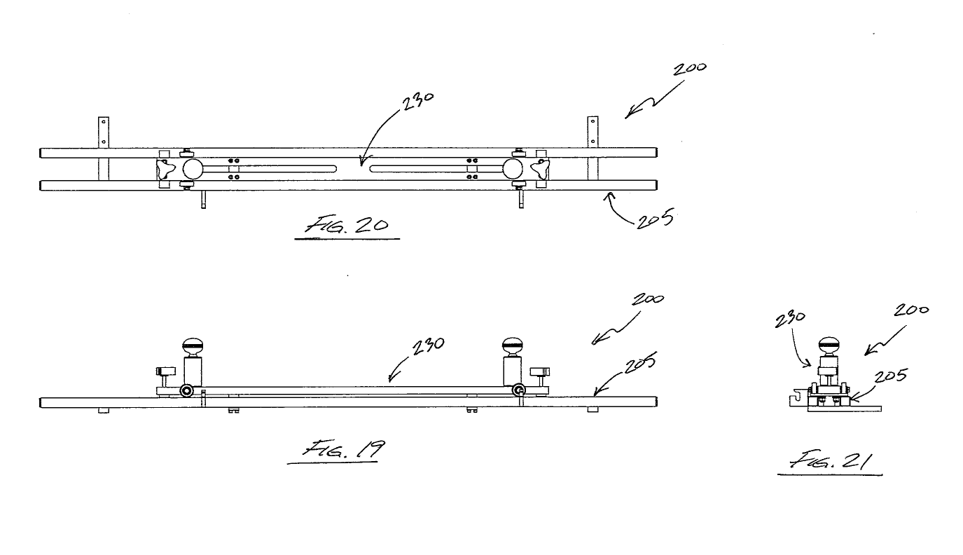

With reference to FIGS. 19-21, entry guide assembly 200 includes frame 205 and a guide carriage assembly 230 that is operative to traverse frame 205. Referring to FIGS. 22A and 22B, frame 205 includes a pair of parallel frame rails 207(1) and 207(2) that are connected by tie bars 211(1) and 211(2). Tie bars 211(1) and 211(2) connect to entry guide assembly mounts 145(1) and 145(2). In this case, tie bars 211(1) and 211(2) are welded to frame rails 207(1) and 207(2). Table brackets 209(1) and 209(2) are attached to frame rail 207(2) by welding, for example. Each table bracket includes a corresponding notch 210(1) and 210(2) which is adapted to receive table pins 132(1) and 132(2), respectively. Guide carriage assembly 230 is mounted to frame 205 and traverses back and forth along frame rails 207(1) and 207(2) as shown in FIGS. 22A and 22B.

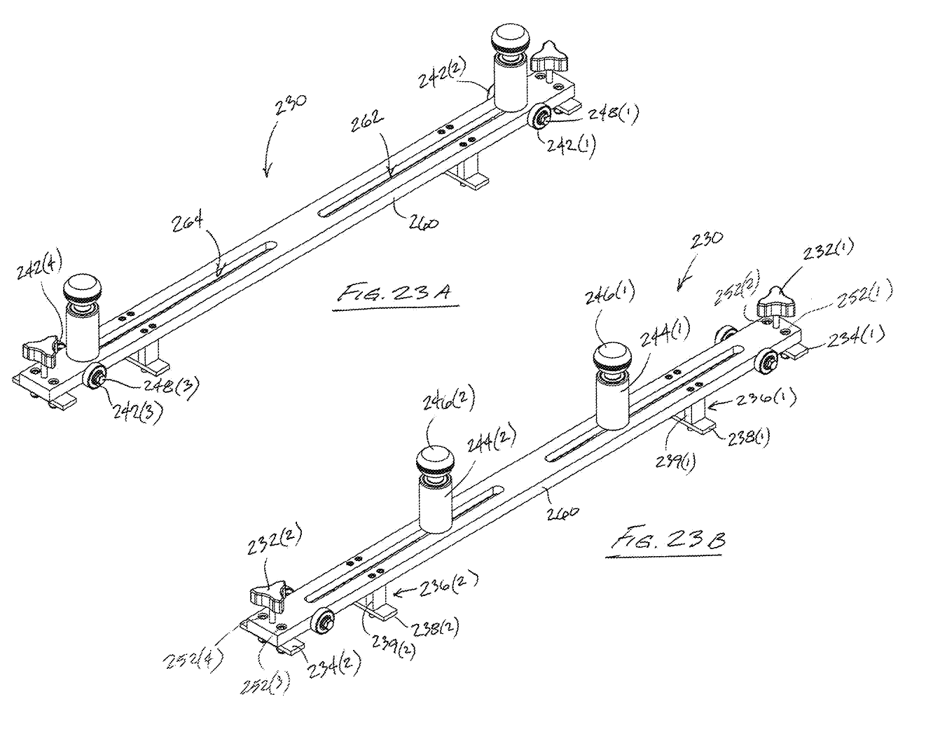

FIG. 22A shows the guide carriage assembly 230 in a first guide position and FIG. 22B shows the guide carriage assembly 230 in a second guide position. The guide carriage 230 is operative to traverse along frame 205 while keeping a fixed distance between entry rollers 244(1) and 244(2). Thus, guide carriage 230 is helpful in assisting a user to guide sheet material into the slitter at an angle. With further reference to FIGS. 23A and 23B, carriage assembly 230 includes a base plate 260 that is captured on frame 205 by retainers 236(1) and 236(2). Each retainer is supported in spaced relation to the frame by a pair of stanchions 239(1) and 239(2). A plurality of bearings 242(1)-242(4) are mounted to base plate 260, each with a respective cap screw 248(1)-248(4). Referring again to FIG. 22A, the guide carriage 230 is captured on frame 205 by bearings 242(1)-242(4) and retainer plates 238(1) and 238(2). It is to be understood that there is enough clearance between frame rails 207(1) and 207(2) and retainer plates 238(1) and 238(2) that the guide carriage 230 may freely traverse the frame.

The distance between entry rollers 244(1) and 244(2) may be adjusted to accommodate different panel widths and different slitting angles as shown in FIGS. 23A and 23B. Entry rollers 244(1) and 244(2) are mounted to base plate 260 along slots 262 and 264 respectively. In this embodiment entry rollers 244(1) and 244(2) are comprised of steel; however, other suitable materials may be used to form the rollers, such as for example aluminum, plastic, rubber, and combinations thereof. Entry rollers 244(1) and 244(2) are attached to base plate 260 with handles in the form of knobs 246(1) and 246(2) that may be loosened in order to reposition the rollers along their respective slots.

Guide carriage 230 is free to move back and forth for slitting tapered panels. However, the carriage may be locked in position when slitting a straight panel. Carriage lock plates 234(1) and 234(2) are connected to respective lock knobs 232(1) and 232(2) such that by turning the lock knobs the lock plates are urged against frame rails 207(1) and 207(2). Lock knobs 232(1) and 232(2) are threaded into base plate 260 and are guided by bolts 252(1)-252(4). Thus, the frame is clamped between the lock plates 234(1) and 234(2) and retainer plates 238(1) and 238(2). Once clamped in this manner the guide carriage is locked in the desired position for slitting a straight panel.

Methods relating to the above described sheet material slitter are also contemplated. The methods thus encompass the steps inherent in the above described mechanical structures and operation thereof. Broadly, one method could include providing a cutting assembly and feeding the sheet material into the cutting assembly. The cutting assembly progressively cuts the sheet material into first and second segments having first and second edge margins respectively. The first and second edge margins are received and supported one above the other. In an embodiment, the method may include providing a sheet material slitter having a cutting assembly. The method includes aligning the sheet material at a desired angle relative to the cutting assembly and inserting the material into the slitter entryway to engage the cutting assembly. The cutting assembly thereby progressively cuts the sheet material into first and second segments having first and second edge margins respectively. The edge margins are captured with first and second guide rollers respectively at a location downstream of the cutting assembly.

Although the technology and methods of using and/or applying the same have been described in language that is specific to certain structures, materials, and methodological steps, it is to be understood that the invention defined in the appended claims is not necessarily limited to the specific structures, materials, and/or steps described. Rather, the specific aspects and steps are described as forms of implementing the claimed invention. Since many embodiments of the invention can be practiced without departing from the spirit and scope of the invention, the invention resides in the claims hereinafter appended.

What is claimed is:

1. A sheet material slitter, comprising:
a frame;
a pair of cooperative slitting knives rotatably mounted to said frame in axially offset relation relative to each other;
a drive motor coupled to said pair of slitting knives and operative to counter-rotate said slitting knives such that sheet material fed into the slitter is drawn through the slitter as the material is cut to form a slit; and
a guide assembly mounted to said frame adjacent said slitting knives, said guide assembly comprising a pair of guide rollers rotatably supported in axially spaced relation relative to each other, each guide roller capable of receiving a respective edge of material along the slit formed in the sheet material exiting said slitting knives.

2. The sheet material slitter according to claim 1, wherein each said guide roller includes a respective groove and wherein said guide rollers are supported such that each said respective groove is capable of receiving a respective edge of the slit.

3. The sheet material slitter according to claim 2, wherein said guide rollers are sheaves.

4. The sheet material slitter according to claim 2, wherein said guide rollers are supported in substantially parallel relation to one another.

5. The sheet material slitter according to claim 4, wherein said guide rollers are supported at an angle with respect to said slitting knives.

6. The sheet material slitter according to claim 2, wherein said pair of slitting knives includes an upper knife and a lower knife and wherein said pair of guide rollers includes an upper guide roller and a lower guide roller each oriented orthogonally to said slitter knives, said upper guide roller being positioned to receive an edge of the slit on the same side of the slit as said lower knife and said lower guide roller being positioned to receive an edge of the slit on the same side of the slit as said upper knife.

7. The sheet material slitter according to claim 1, including an alignment indicator.

8. The sheet material slitter according to claim 7, wherein said alignment indicator is located adjacent said slitting knives and opposite said guide assembly.

9. The sheet material slitter according to claim 8, wherein said alignment indicator comprises a laser.

10. The sheet material slitter according to claim 1, wherein said frame has an entryway with a width and a height, said frame configured to support said slitting knives and said guide assembly at a location along said width.

11. The sheet material slitter according to claim 10, wherein said slitting knives and said guide assembly are located approximately midway between lateral side ends of said entryway.

12. The sheet material slitter according to claim 10, wherein said motor is attached to an end of said frame, and including a pair of drive shafts extending from said motor to said slitter knives, whereby at least a portion of said entryway is unobstructed.

13. The sheet material slitter according to claim 10, including at least one accessory attached to said frame, said accessory selected from the group consisting of a support stand, an upstream support table, and a downstream support table.

14. A sheet material slitter apparatus, comprising:
a frame having an entryway with a width and a height;
a cutting assembly mounted in said frame and operative to progressively cut sheet material fed into said entryway into first and second segments each having a respective edge margin;
a guide assembly mounted to said frame adjacent said cutting assembly, said guide assembly comprising a pair of grooved guide rollers rotatably supported in axially spaced relation relative to each other, each said grooved guide roller capable of receiving a respective edge margin; and
at least one accessory attachment mated to said frame.

15. The sheet material slitter apparatus according to claim 14, wherein said at least one accessory attachment is a slitter support stand.

16. The sheet material slitter apparatus according to claim 14, wherein said at least one accessory attachment is an upstream support table.

17. The sheet material slitter apparatus according to claim 14, wherein said at least one accessory attachment is a downstream support table.

18. A guide assembly for use on a sheet material slitter that includes a pair of slitting knives, the guide assembly comprising:
a pair of grooved guide rollers each rotatably mounted on a corresponding roller mount, each said roller mount adapted for attachment to the slitter adjacent the slitting knives such that said grooved guide rollers are supported in axially spaced relation to each other and such that a groove on each said grooved guide roller is capable of receiving a respective edge of material along a slit formed in sheet material that exits the slitting knives.

19. The guide assembly according to claim 18, wherein said grooved guide rollers are supported in substantially parallel relation to one another.

20. The guide assembly according to claim 18, wherein said pair of grooved guide rollers is supported at an angle with respect to said slitting knives.

21. The guide assembly according to claim 18, wherein the pair of slitting knives includes an upper knife and a lower knife and wherein said pair of grooved guide rollers includes an upper guide roller and a lower guide roller, said pair of grooved guide rollers oriented at least 45 degrees from the pair of slitter knives, said upper guide roller being positioned to receive an edge of the slit on the same side of the slit as the lower knife and said lower guide roller being positioned to receive an edge of the slit on the same side of the slit as the upper knife.

22. A method of slitting sheet material, the method comprising:
providing a cutting assembly;
feeding the sheet material into said cutting assembly to progressively cut the sheet material into first and second segments having first and second edge margins respectively;
receiving the first edge margin;
receiving the second edge margin; and
supporting the first edge margin above the second edge margin.

23. A method of slitting sheet material, the method comprising:
providing a sheet material slitter having a cutting assembly;
aligning the sheet material at a desired angle relative to said cutting assembly;
inserting the materials into the sheet material slitter entryway to engage the cutting assembly thereby to progressively cut the sheet material into first and second segments having first and second edge margins respectively; and
capturing the first and second edge margins with first and second guide rollers respectively at a location downstream of the cutting assembly.
